(19) United States
(12) Patent Application Publication
(10) Pub. No.: US 2025/0008500 A1
(43) Pub. Date: Jan. 2, 2025

(54) TRANSMISSION OF SRS FOR POSITIONING CONFIGURED OUTSIDE AN INITIAL UL BWP IN AN UNCONNECTED STATE

(71) Applicant: QUALCOMM Incorporated, San Diego, CA (US)

(72) Inventors: Alexandros MANOLAKOS, Athens, Attikí (GR); Jing LEI, San Diego, CA (US); Peter GAAL, San Diego, CA (US)

(21) Appl. No.: 18/697,838

(22) PCT Filed: Sep. 28, 2022
(86) PCT No.: PCT/US2022/077148

§ 371 Date: Apr. 2, 2024

(30) Foreign Application Priority Data
Dec. 9, 2021 (GR) 20210100863

(51) Int. Cl. H04W 72/0457; H04L 5/00

(52) U.S. Cl. CPC H04W 72/0457; H04L 5/0051

(57) ABSTRACT

The reduction of a timing collision between the Sounding Reference Signal (SRS) instances when a user equipment (UE) is in a Radio Resource Control (RRC) inactive state and SRS is configured to use an uplink (UL) bandwidth part (BWP) different than a UL BWP of messages transmitted by the UE in the RRC inactive state. More particularly, embodiments may implement collision-reduction techniques and establish action times for canceling the transmission of one or more SRS instances.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

Wireless communication networks, such as cellular systems providing fourth-generation (4G) service (e.g., Long-Term Evolution (LTE)) and fifth-generation (5G) service can, in addition to providing data connectivity to wireless devices, provide positioning services to determine the location of mobile devices within a coverage regions of the wireless communication network. For example, a fifth generation (5G) wireless standard, referred to as New Radio (NR), may determine the position of a user equipment (UE) using measurements (e.g., made by transmission/reception points (TRPs) of a 5G wireless network) of wireless signals transmitted by the UE. The Sounding Reference Signal (SRS) for positioning is one such signal. The UE may be configured to transmit a series of SRS instances for positioning. Collision may occur, however, between one or more of the SRS instances and other signals sent or received by the UE.

### BRIEF SUMMARY

Embodiments described herein provide for the reduction of collision between the SRS instances when a UE is in an unconnected state with respect to a wireless communication network (including a Radio Resource Control (RRC) inactive state RRC Idle state, or Discontinuous Reception (DRX) state) and SRS is configured to use an uplink (UL) bandwidth part (BWP) different than a UL BWP used by the UE to transmit messages in the unconnected state. More particularly, embodiments may implement collision-reduction techniques including establishing action times for canceling the transmission of one or more SRS instances.

An example method of modifying transmission of sounding reference signal (SRS) by a user equipment (UE) during an unconnected state relative to a communication network, according to this disclosure, may comprise receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network. The method also may comprise canceling a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap, (B) the SRS BWP and a BWP of a second message have the common center frequency and a time difference between the scheduled transmission of the SRS instance and the second message is less than the first threshold time gap, (C) the SRS BWP and the DL BWP have different center frequencies and the time difference between the receiving of the first message and the scheduled transmission of the SRS instance is less than an SRS switching time of the UE, (D) SRS BWP and the BWP of the second message have the different center frequencies and the time difference between the scheduled transmission of the SRS instance and the second message is less than the SRS switching time of the UE, or (D) a Physical Random Access Channel (PRACH) has been transmitted by the UE. The first threshold time gap may be shorter than the SRS switching time of the UE and the second message may comprise a second DL message from the TRP or a UL message from the UE.

An example user equipment (UE) for modifying transmission of sounding reference signal (SRS) during an unconnected state relative to a communication network, according to this disclosure, may comprise a transceiver, a memory, one or more processors communicatively coupled with the transceiver and the memory, wherein the one or more processors are configured to receiving, via the transceiver, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network. The one or more processors further may be configured to cancel a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap, (B) the SRS BWP and a BWP of a second message have the common center frequency and a time difference between the scheduled transmission of the SRS instance and the second message is less than the first threshold time gap, (C) the SRS BWP and the DL BWP have different center frequencies and the time difference between the receiving of the first message and the scheduled transmission of the SRS instance is less than an SRS switching time of the UE, (D) SRS BWP and the BWP of the second message have the different center frequencies and the time difference between the scheduled transmission of the SRS instance and the second message is less than the SRS switching time of the UE, or (D) a Physical Random Access Channel (PRACH) has been transmitted by the UE. The first threshold time gap may be shorter than the SRS switching time of the UE and the second message may comprise a second DL message from the TRP or a UL message from the UE.

An example apparatus for modifying transmission of sounding reference signal (SRS) by a user equipment (UE) during an unconnected state relative to a communication network, according to this disclosure, may comprise means for receiving a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network. The apparatus further may comprise means for canceling a scheduled transmission of an SRS instance of the one or more SRS instances by the UE based on determining: (A) the SRS BWP and the DL BWP have a common center frequency and a time difference between the receiving of the first message and the scheduled transmission of the SRS instance is less than a first threshold time gap, (B) the SRS BWP and a BWP of a second message have the common center frequency and a time difference between the scheduled transmission of the SRS instance and the second message is less than the first threshold time gap, (C) the SRS BWP and the DL BWP have different center frequencies and the time difference between the receiving of the first message and the scheduled transmission of the SRS instance is less than an SRS switching time of the UE, (D) SRS BWP and the BWP of the second message have the different center frequencies and the time difference between the scheduled transmission of the SRS instance and the second message is less than the SRS switching time of the UE, or (D) a Physical Random Access Channel (PRACH) has been transmitted by the UE. The first threshold time gap may be shorter than the SRS switching time of the UE and the second message may comprise a second DL message from the TRP or a UL message from the UE.

According to this disclosure, an example non-transitory computer-readable medium stores instructions for modifying transmission of sounding reference signal (SRS) by a user equipment (UE) during an unconnected state relative to a communication network, the instructions comprising code for receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network. The instructions further may comprise code for canceling a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap, (B) the SRS BWP and a BWP of a second message have the common center frequency and a time difference between the scheduled transmission of the SRS instance and the second message is less than the first threshold time gap, (C) the SRS BWP and the DL BWP have different center frequencies and the time difference between the receiving of the first message and the scheduled transmission of the SRS instance is less than an SRS switching time of the UE, (D) SRS BWP and the BWP of the second message have the different center frequencies and the time difference between the scheduled transmission of the SRS instance and the second message is less than the SRS switching time of the UE, or (D) a Physical Random Access Channel (PRACH) has been transmitted by the UE. The first threshold time gap may be shorter than the SRS switching time of the UE and the second message may comprise a second DL message from the TRP or a UL message from the UE.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a diagram showing an example of a frame structure for NR and associated terminology.

FIGS. 4 and 5 are signal flow diagrams for connecting user equipment (UE) to a transmission/reception point (TRP).

FIGS. 6 and 7 are timing diagrams illustrating examples of time gaps (buffer periods) between the transmission of Sounding Reference Signal (SRS) transmission and other messages.

FIGS. 8 and 9 are timing diagrams illustrating examples of a timing conflict between Sounding Reference Signal (SRS) transmission and a subsequently-transmitted message.

FIG. 10 is a flow diagram of a method of modifying transmission of SRS (e.g., SRS for positioning) by a UE, according to an embodiment.

FIG. 11 is a block diagram of an embodiment of a UE, which can be utilized in embodiments as described herein.

FIG. 12 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the term “bandwidth part” (BWP) refers to a subset or part of a total carrier bandwidth, e.g., as defined in relevant 3GPP standards. A BWP forms a set of contiguous common resource blocks (CRBs) within the total carrier bandwidth. Currently, a user equipment (UE) can be configured with up to four downlink (DL) BWPs and up to four uplink (UL) BWPs for each serving cell. Due to UE battery consumption, only one BWP in the downlink and one in the uplink are active at a given time on an active serving cell. The active BWP defines the UE's operating bandwidth within the cell's operating bandwidth. Non-active BWPs may be deactivated and may not transmit or receive data. For time-division duplexing (TDD), a BWP pair (an active UL BWP and active DL BWP) may have the same center frequency. The network can dynamically switch the UE to a desired BWP when the desired BWP is not active.

Additionally, unless otherwise specified, references to “reference signals,” “positioning reference signals,” “reference signals for positioning,” and the like may be used to refer to signals used for positioning of a UE. As described in more detail herein, such signals may comprise any of a variety of signal types but may not necessarily be limited to a Positioning Reference Signal (PRS) as defined in relevant wireless standards. Further, as used herein, a Sounding Resource Signal (SRS) may comprise an UL PRS or “SRS for positioning” as defined by the relevant 3GPP wireless standard.

As noted, described herein provide for the reduction of collision between the SRS instances when a UE is in an unconnected state relative to a communication network and SRS is configured to use an UL BWP different than the initial UL BWP. More particularly, embodiments may implement collision-reduction techniques including establishing action times for canceling the transmission of one or more SRS instances. Additional details will follow after an initial description of relevant systems and technologies.

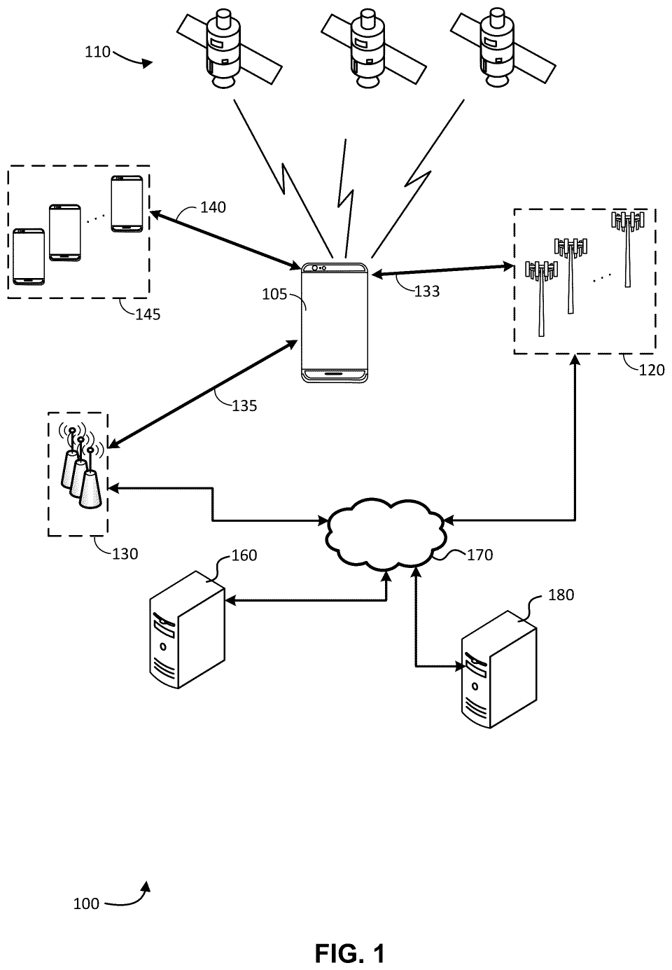

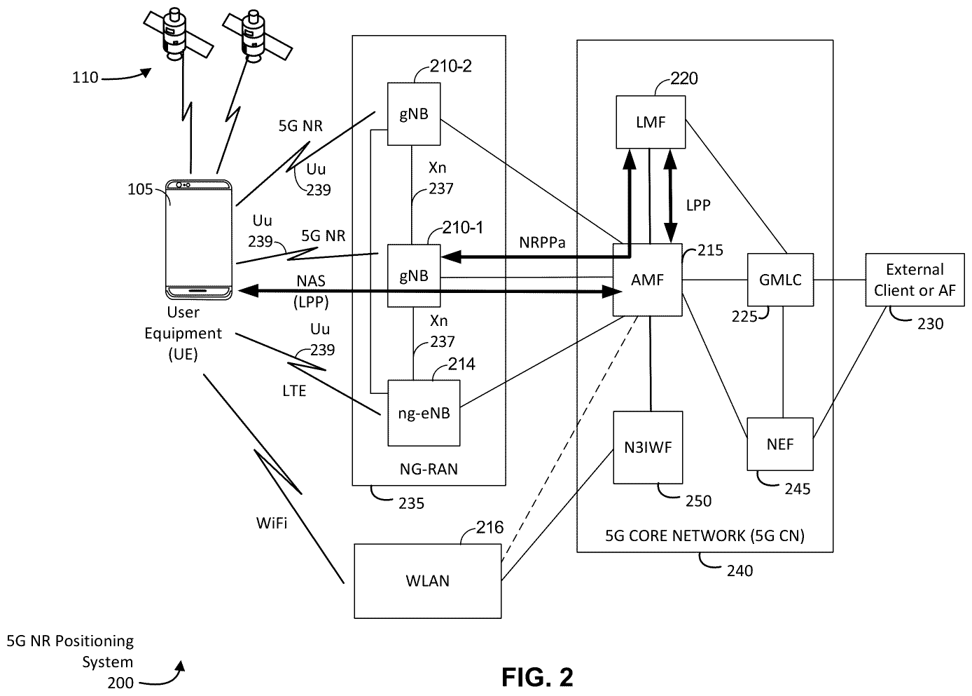

FIG. 1 is a simplified illustration of a positioning system 100 in which a UE 105, location server 160, and/or other components of the positioning system 100 can use the techniques provided herein for modifying the transmission of Sounding Reference Signal (SRS) for positioning, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

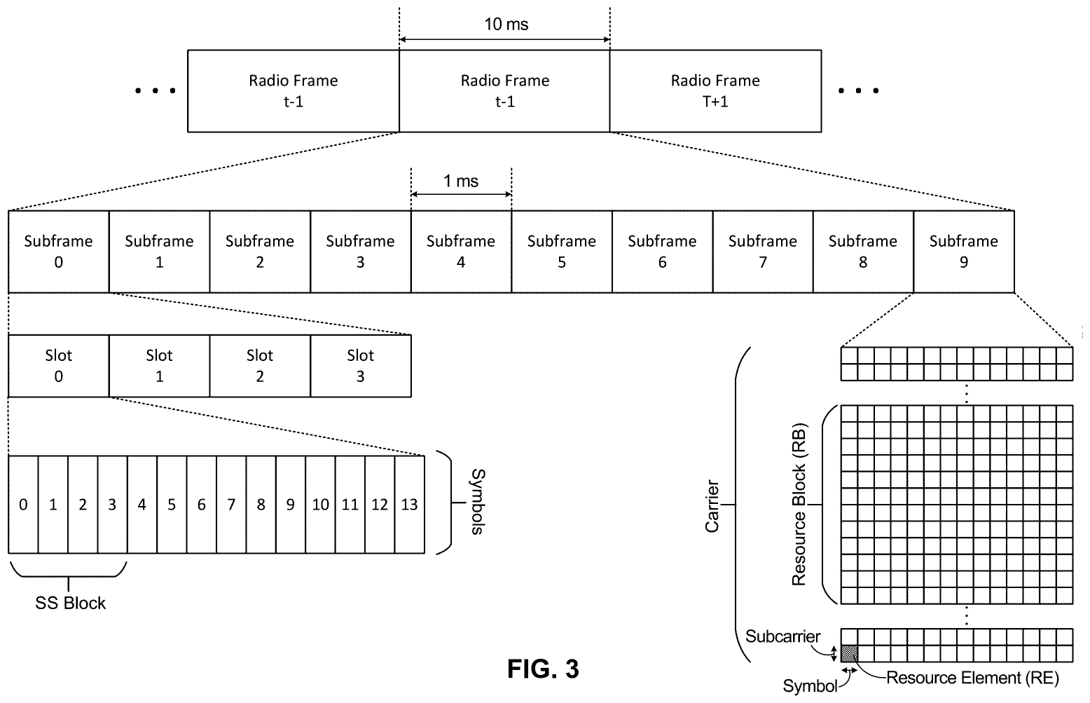

FIG. 3 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 3 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 3. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

A UE may transmit radio frames, or other physical layer signaling sequences, supporting SRS signals according to frame configurations either similar to, or the same as that, shown in FIG. 3, which may be measured and used for determining a position estimate for a UE (e.g., any of the UEs described herein).

A collection of resource elements that are used for transmission of SRS is referred to as an “SRS resource.” The collection of resource elements can span multiple PRBs in the frequency domain and N (e.g., 1 or more) consecutive symbol(s) within a slot in the time domain. In a given OFDM symbol, an SRS resource occupies consecutive RBs. An SRS resource is described by at least the following parameters: SRS resource identifier (ID), sequence ID, comb size-N, resource element offset in the frequency domain, starting slot and starting symbol, number of symbols per SRS resource (i.e., the duration of the SRS resource), and quasi-collocation (QCL) information. Currently, one antenna port is supported. The comb size indicates the number of subcarriers in each symbol carrying SRS.

An “SRS resource set” is a set of SRS resources used for the transmission of SRS signals, where each SRS resource has an SRS resource ID. In addition, the SRS resources in an SRS resource set are associated with the same UE. An SRS resource set is identified by an SRS resource set ID. An SRS resource ID in an SRS resource set is associated with a single beam (and/or beam ID) transmitted from a UE. That is, each SRS resource of an SRS resource set may be transmitted on a different beam.

An “SRS occasion” is one instance of a periodically repeated time window (e.g., a group of one or more consecutive slots) where SRS are expected to be transmitted. An SRS occasion may also be referred to as an “SRS instance,” “SRS positioning occasion,” a “positioning occasion,” or simply an “occasion.”

Note that the terms “sounding reference signal” and “SRS” may sometimes refer to specific reference signals that are used for positioning in LTE systems. While the discussion herein refers to sounding reference signals and SRS, the discussion may be applied to other types of positioning signals.

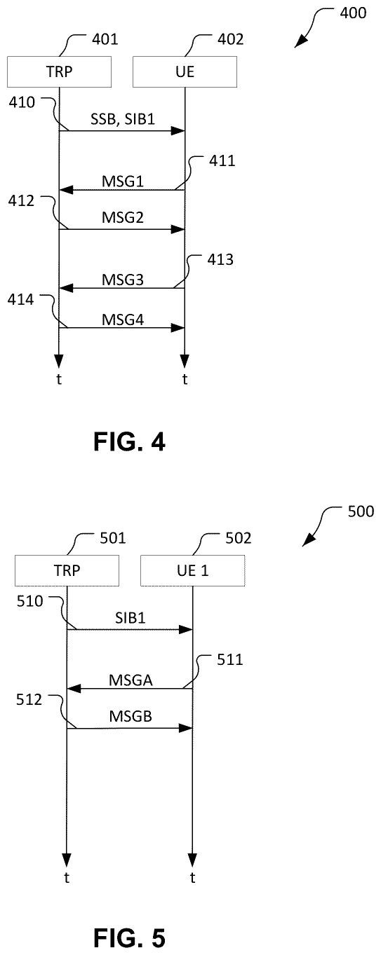

Referring to FIG. 4, with further reference to FIGS. 1-3, a TRP 401 (e.g., of the base station 120) and a UE 402 (e.g., the UE 105) are configured to communicate with each other according to a signal flow 400 to establish RRC connection of the UE 402 to a communication network (e.g., comprising base stations 120 and the network 170 shown in FIG. 1) including the TRP 401. Thus, the signal flow 400 may be conducted while the UE 402 is in an unconnected state, in which the UE 402 is unconnected from the communication network of the TRP 401. In the unconnected state, the UE 402 is not connected to, or synchronized with, the communication network, has no active BWP (bandwidth part), and cannot transmit information to, or receive information from, the communication network using unicast transmission. Examples of the unconnected state include RRC Idle defined in 3GPP, RRC Inactive defined in 3GPP, and a DRX (Discontinuous Reception) state, e.g., long DRX cycle. The signal flow 400 is a four-step process using the Random Access Channel (RACH) for connecting the TRP 401 and the UE 402. The naming conventions (e.g., MSG1, MSG2, etc.) are used in the relevant 3GPP specification, and references herein to “MSG1,” “MSG2,” etc. may refer to the particular corresponding messages shown in FIG. 4 and used the relevant 3GPP specification to describe a four-step RACH process. Once connected, the UE 402 and the TRP 401 may exchange unicast messages. The signal flow 400 may be followed to transition from an unconnected state of the UE 402 (i.e., the UE 402 is outside of a connected state with the communication network, e.g., through and including the TRP 401) to a connected state. For example, the signal flow 400 may be followed when the UE 402 is powered up or wakes from sleeping, or desires to transition from an RRC idle state or RRC inactive state (in either of which the UE 402 is unconnected) to an RRC connected state.

At stage 410 of the signal flow 400, the TRP 401 sends synchronization information in an SSB message and a SIB1 synchronization information block. The TRP 401 broadcasts the SSB and SIB1 messages. The UE 402 receives the SSB and from the SSB identifies the SIB1 message. The UE 402 receives the SIB1 message from the TRP 401.

From the SIB1 message, the UE 402 determines one or more transmission properties of a RACH preamble sequence to be sent to the TRP 401 at stage 411 in a first message MSG1. The UE 402 selects a RACH preamble sequence and determines a RACH occasion (RO) (e.g., which may occur periodically, e.g., every 10 ms, 20 ms, 40 ms, 80 ms, 160 ms) according to SSB-to-RO mapping for transmitting the RACH preamble. For example, the UE 402 may determine to send the RACH preamble at the next (in time) RACH occasion. The RO is the time/frequency opportunity for the UE 402 to transmit a RACH preamble. There are different RACH preamble formats, and correspondingly different RO sizes. Due to reciprocity of antennas, the UE 402 may determine which receive (Rx) beam best received a synchronization signal (e.g., the SSB) and select the corresponding transmit (Tx) beam for transmitting the RACH preamble. If reciprocity is available at the TRP 401, then the UE 402 may transmit the MSG1 once, and otherwise may repeat the MSG1 message for each of the TRP Tx beams. The UE 402 may be configured to send the first message MSG1 using the PRACH (Physical RACH).

The TRP 401 is configured to respond to the MSG1 message sent at stage 411 (also called step 1) by sending a response or second message MSG2 at stage 412 (also called step 2). The response message MSG2 may be a random access response (RAR) UL grant that the TRP 401 sends using the PDSCH (Physical Downlink Shared CHannel) with a selected beam. The second message MSG2 acknowledges receipt of the first message MSG1 and may provide some collision avoidance information. Based on the messages MSG1, MSG2, the TRP 401 and the UE 402 may establish coarse beam alignment that may be used in stages 413, 414 discussed below.

The UE 402 is configured to receive the response message MSG2 and response, at stage 413 (also called step 3), by sending a third message MSG3 using resources scheduled by the TRP 401. The TRP 401 is thus aware of where to detect the third message MSG3 and which TRP Rx beam should be used to detect the third message MSG3. The UE 402 may be configured to send the third message MSG3 using the PUSCH (Physical Uplink Shared CHannel) using the same beam or a different beam than the UE 402 used to send the first message MSG1.

At stage 414 (also called step 4), the TRP 401 confirms receipt of the third message MSG3 by sending a fourth message MSG4 in the PDSCH using the TRP Tx beam determined in stage 413. At this point, the UE 402 has identified synchronization between the TRP 401 and the UE 402, has identified resources for transmit and receive, and is connected to the communication network (through and including the TRP 401), i.e., is in a connected state (an RRC connected state).

Referring also to FIG. 5, a TRP 501 (e.g., of the base station 120) and a UE 502 (e.g., the UE 105) are configured to communicate with each other according to a signal flow 500 to establish RRC connection of the UE 502 to a communication network (e.g., comprising base stations 120 and the network 170 shown in FIG. 1) including the TRP 501. The signal flow 500 is a two-step process using the RACH for connecting the TRP 501 and the UE 502. The signal flow 500 is effectively a two-step version of the four-step signal flow 400 shown in FIG. 4. At stage 510, the UE 502 receives the SSB and SIB1. At stage 511 (step 1 in the two-step process), the UE 502 sends an initial message MSGA after receipt of the SSB and SIB1. The initial message MSGA uses both PRACH and PUSCH. At stage 512 (step 2 in the two-step process), the TRP 501 sends a response message MSGB to the UE 502 to connect the UE 502 to the TRP 501.

Situations may arise when a UE is in an unconnected state relative to a communication network and configured to transmit SRS for positioning while performing the four-step or two-step PRACH process (e.g., illustrated in FIGS. 4 and 5, respectively). Collision avoidance scenarios have been contemplated in which the UE is configured to transmit SRS for positioning in an unconnected state using the initial UL BWP. The initial UL BWP in this situation may comprise the BWP used to transmit PUSCH/PUCCH/SRS in the legacy scenarios. The initial DL BWP may comprise the BWP that is used to receive PDCCH for paging, etc., in DL. However, in cases where the UE is configured to transmit SRS for positioning in an unconnected state using a different BWP than the initial UL BWP, thereby requiring retuning, it is not clear what would qualify as a “collision,” given the fact that a period of time is needed for retuning both before and after a transmission of an SRS occurrence. The BWP with which SRS is transmitted may be referred to herein as the SRS BWP.

Embodiments herein provide for establishing time gaps (or time windows) that identify collision and establish action times for dropping SRS transmission for collision avoidance in cases where the transmission of SRS during an unconnected state is configured outside the initial UL BWP. Some embodiments can leverage established SRS switching times (e.g., “SRS-SwitchingTimeNR” in these 3GPP standard) in which a UE conducts a full RF re-tune by switching between receiving and/or sending messages in a bandwidth of first component carrier (CC) and transmitting SRS in a second CC. In some embodiments, the SRS switching time may correspond to the UL BWP switching times (e.g., as defined in 3GPP Technical Specification (TS) 38.133), where BWP switch delay may be determined by slot length and UE capability (e.g., Type 1 or Type 2). For example, for slot lengths of 1, 0.5, 0.25, and 0.125 ms, BWP switch delay respectively may be 1, 2, 3, and 6 slots in length for a UE with Type 1 capabilities, and 3, 5, 9, and 18 for a UE with Type 2 capabilities.

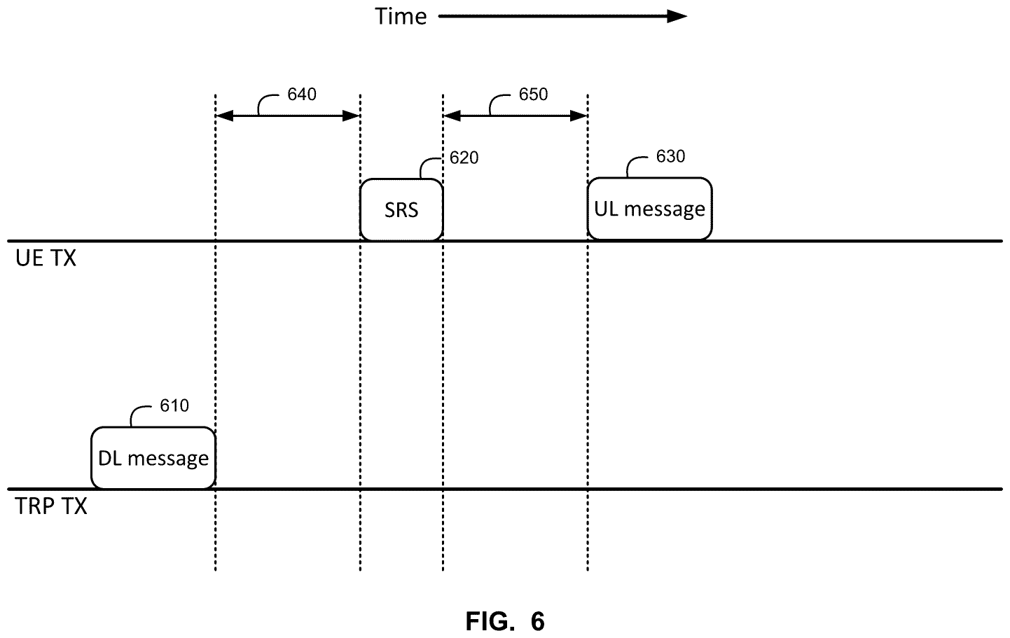

FIG. 6 is a timing diagram illustrating a generalized scenario in which a TRP transmits a DL message 610, followed by the UE transmitting an SRS instance 620 and a UL message 630. The DL message 610 and/or UL message 630 may be transmitted, for example, as part of a PRACH process (e.g., as illustrated in FIGS. 4 and 5) while the UE is operating in an unconnected state. Further, the SRS instance 620 may be transmitted in accordance with an SRS configuration, which may specify a particular SRS BWP, cyclic prefix (CP), and/or subcarrier spacing (SCS). As noted, the SRS BWP may be different than the initial UL BWP used by the UE to transmit messages as part of the PRACH process. A first time gap 640 comprises a length of time between the DL message 610 and the SRS instance 620, and a second time gap 650 comprises a length of time between the SRS instance 620 and the UL message 630.

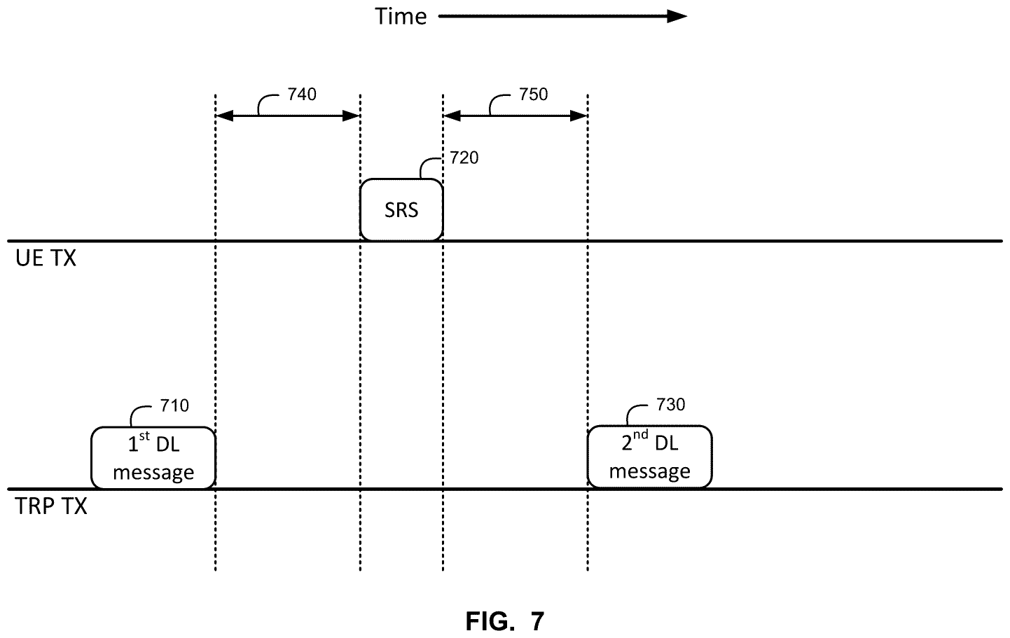

FIG. 7 is a timing diagram similar to FIG. 6, in which the TRP transmits a first DL message 710 and the UE transmits an SRS instance 720. Here, however, the SRS instance 720 is followed by the TRP transmitting a second DL message 730. A first time gap 740 comprises a length of time between the first DL message 710 and the SRS instance 720, and a second time gap 750 comprises a length of time between the SRS instance 720 and the second DL message 730.

A timing conflict may arise between messages on either side of a time gap (e.g., 640, 650, 740, and 750) in cases where the time gap is shorter than a minimum time gap necessary to avoid conflict. In particular, minimum time gaps may be associated with RF tuning (if necessary) conducted by the UE to transmit an SRS instance (e.g., 620 or 720) or subsequent message (e.g., UL message 630 or second DL message 730). According to some embodiments, in cases where the initial BWP (e.g., in which DL messages 610, 710, and 730 and UL message 630 are transmitted) has the same center frequency as the SRS BWP (with which SRS instances 620 and 720 are transmitted), a minimum time gap) may be relatively short: one OFDM symbol (the actual duration of which may vary, depending on the SCS used). In other embodiments, the minimum time gap may be larger or smaller.

For example, in cases where the initial BWP and SRS BWP have a common center frequency, the minimum time gap may be one, two, three, or N symbols, where N is some number of symbols. According to some embodiments, if a timing conflict occurs between a scheduled SRS instance and another message (e.g., a time gap between the SRS instance and the other message is shorter than a minimum time gap), then the SRS instance may be dropped. Further, according to some embodiments, all subsequent SRS instances of an SRS configuration may be dropped.

In some embodiments, a UE may drop in SRS instance if the SRS instance occurs in the same slot with a PRACH or is within N symbols of a PRACH. Put differently, for SRS transmission in RRC_INACTIVE state, a UE does not transmit SRS in a same slot with a PRACH or when a gap between the first or last symbol of a PRACH transmission in a first slot is separated by less than N symbols from the last or first symbol, respectively, of a SRS transmission in a second slot where N=2 for μ=0 or μ=1, N=4 for μ=2 or μ=3, and μ is the SCS configuration of the initial UL BWP if SRS is associated with the initial UL BWP, or of the SRS configuration if a separate SCS is provided.

In embodiments in which the SRS BWP used to transmit the SRS has a different center frequency than the initial BWP (e.g., a common center frequency is not possible), the minimum time gap between a DL message and SRS instance (e.g., time gaps 640, 740, and 750) may be relatively larger (e.g., larger than one OFDM symbol) because RF retuning may be required by the UE. A similar minimum time gap due to similar retuning may be applied to a time gap (e.g., time gap 650) between an SRS instance using the SRS BWP and a UL message using an initial UL BWP (different than the SRS BWP). In such cases, the minimum time gap may be set as the SRS switching time (e.g., SRS-SwitchingTimeNR), which may be selected from a set of enumerated values, as provided in the relevant 3GPP specification. In some embodiments, a DL SRS switching time (e.g., a switching time between an SRS instance and a DL message, such as time gaps 640, 740, and 750) may be set at a first value, and a UL SRS switching time (e.g., a switching time between an SRS instance and another UL message, such as time gap 650) may be set at a second value, which may be the same or different than the first value. According to some embodiments, the SRS switching time (e.g., including the UL SRS switching time and/or DL SRS switching time) may be set at a certain time value, such as 0 μs, 30 μs, 100 μs, 140 μs, 200 μs, 300 μs, 500 μs, or 900 μs.

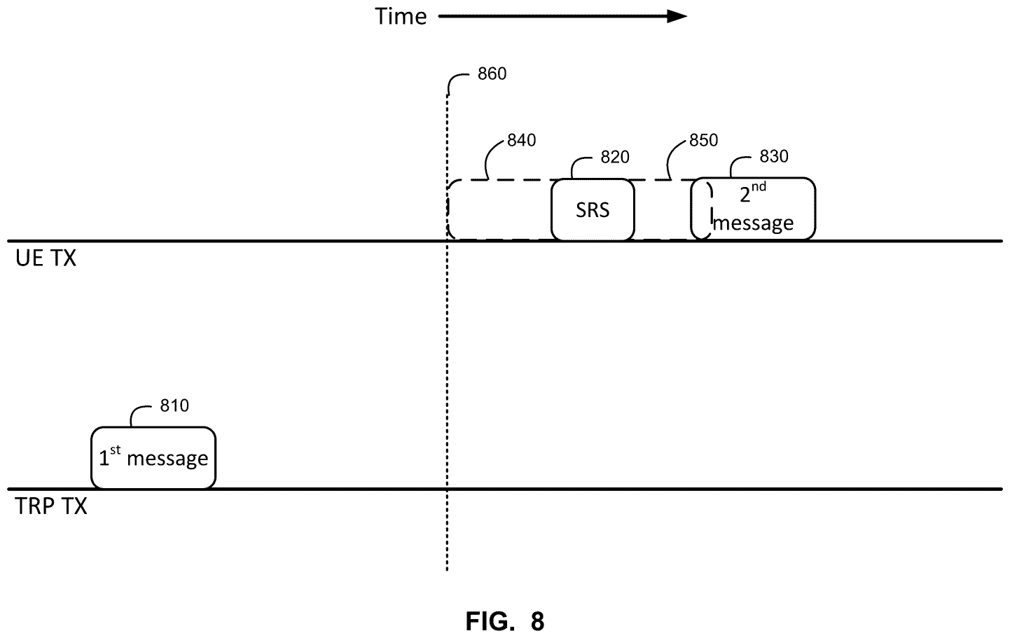

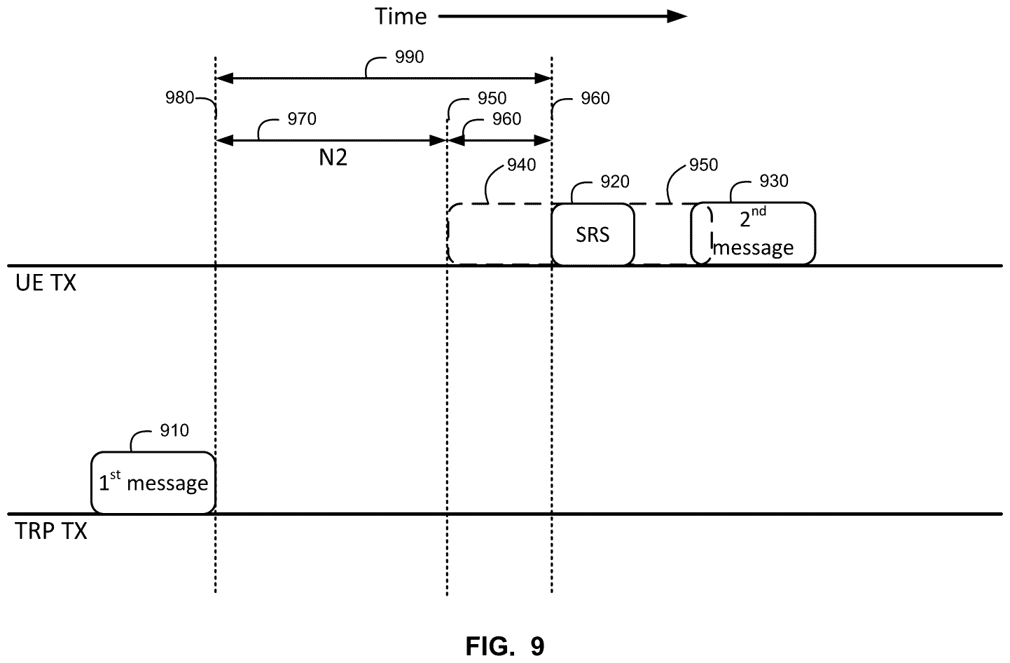

According to some embodiments, action times may be established for SRS when collisions occur during an unconnected state of the UE. An action time is a time by which an upcoming collision must be identified to be resolved. In other words, if an upcoming collision is identified after the collision time, the collision may be unavoidable because a transmission (e.g., of an SRS instance) may already be pipelined. FIGS. 8 and 9 illustrate how action times for SRS may be determined in an unconnected state.

FIG. 8 is a timing diagram, similar to FIGS. 6 and 7, showing a scenario in which a UE is scheduled to follow a transmission of a first message 810 by a TRP with the transmission of both an SRS instance 820 and a second message 830. Here, the first message 810 may correspond with any DL reception while the UE is in an unconnected state, such as SSB, SIB1, MSG2, or MSG4 of FIG. 4, or SIB1 or MSGB of FIG. 5; and second message 830 may correspond with a responsive UL message, such as MSG1 or MSG3 of FIG. 4, or MSGA of FIG. 5. Because the SRS BWP is different than the initial DL BWP with which the UE receives the first message 810, the UE uses a first switching period 840 to perform RF tuning to be able to transmit the SRS instance 820 via the SRS BWP. Similarly, because the initial UL BWP with which the UE is to transmit the second message 830 is different than the SRS BWP, the UE uses a second switching period 850 to be able to transmit the second message 830 via the initial UL BWP. As shown, the second switching period 850 extends into a time during which the second message 830 is to be transmitted, thereby resulting in a conflict. (A conflict may also occur when the second message 830 overlaps directly with the SRS instance 820 itself.) Because there is a conflict between the SRS instance 820 and the second message 830, the UE may omit transmitting the SRS instance 820 (e.g., in accordance with the previously-described collision avoidance methods), and (optionally) all subsequent SRS instances in the SRS configuration. To ensure the UE successfully drops the transmission of the SRS instance 820, the UE may need to identify the collision at a point in time 860 prior to the beginning of the first switching period 840. FIG. 9 indicates how a specific action time may be determined.

FIG. 9 is a timing diagram showing a conflict similar to FIG. 8, showing a scenario in which a UE is scheduled to follow a transmission of a first message 910 by a TRP with the transmission of both an SRS instance 920 and a second message 930, where the SRS instance 720 is preceded by a first switching period 940 and followed by a second switching duration 960. Point 950 marks the beginning of the first switching period 940, and indicates a point in time, according to some embodiments, after which the transmission of the SRS instance 920 has already been pipelined and can no longer be canceled. Point 980, therefore, precedes the transmission of the SRS instance 920 by the switching duration 960 of the first switching period 940, and marks the time by which the UE must identify conflict between the transmission of the SRS instance 920 and the second message 930 (and cancel the transmission of the SRS instance 920). In many situations, (e.g., a PRACH process) the first message 910 may comprise Downlink Control Information (DCI) that schedules the transmission of the second message 930. Moreover, it takes a period of time (specified as N2 in 3GPP) for the UE to decode the first message 910, denoted in FIG. 9 as decoding duration 970. Thus, the UE can avoid the conflict (e.g. by canceling the transmission of the SRS instance 920) if the first message 910 is received before the point 980, the action time, which precedes the transmission of the SRS 920 by a duration 990 comprising the sum of the decoding duration 970 and the switching duration 960. According to some embodiments, duration 990 may be measured as the time interval between the last symbol of the first message 910 and the first symbol of the SRS instance 920.

More generally, for SRS transmissions by a UE in an unconnected state where the SRS transmissions use an SRS BWP with a different center frequency than the initial BWP with which a DL message is transmitted, embodiments may use an action time by which the DL message scheduling a UL message is to be transmitted so that the UE can determine whether there is a conflict. This action time may be defined as a time that precedes the transmission of an SRS instance by a time duration comprising the sum of (i) a time it takes for the UE to decode the DL message (e.g., an established N2 time period) and (ii) the SRS switching time preceding the transmission of the SRS instance. As noted, the SRS switching time may be a single symbol if the SRS BWP and initial BWP have the same center frequency. If the SRS BWP and initial BWP have different center frequencies, then longer switching times (e.g., a larger numbers of symbols) may be established. The use of this action time may apply, for example, in instances in which the DL message comprises a Physical Downlink Control Channel (PDCCH) that schedules the UL message comprising a PUCCH, or where the DL message comprises a PDSCH that schedules the UL message comprising a PUSCH.

This can be implemented as follows for two particular circumstances. First, for SRS in RRC_Inactive not associated with the UL BWP, the UE shall apply the prioritization/dropping between the SRS and the msg3 transmission (e.g., as shown in FIG. 4) taking into account DCI(s) for which the time interval between the last symbol of PDCCH and the first symbol of SRS is at least N2+SRSSwitchingTime. Second, for SRS in RRC_Inactive not associated with the UL BWP, the UE shall apply the prioritization/dropping between the SRS and the PUCCH transmission taking into account DCI(s) for which the time interval between the last symbol of PDCCH and the first symbol of SRS is at least N2+SRSSwitchingTime.

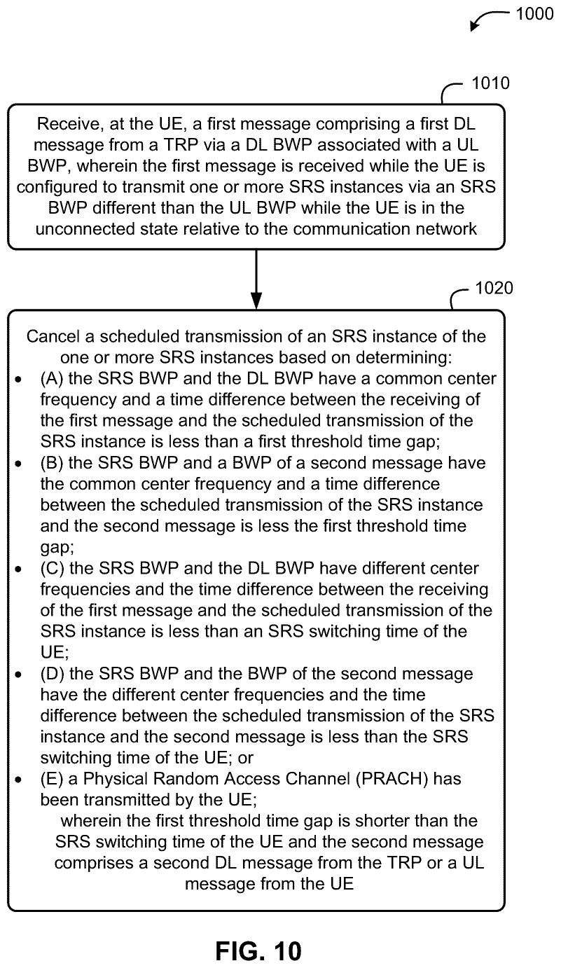

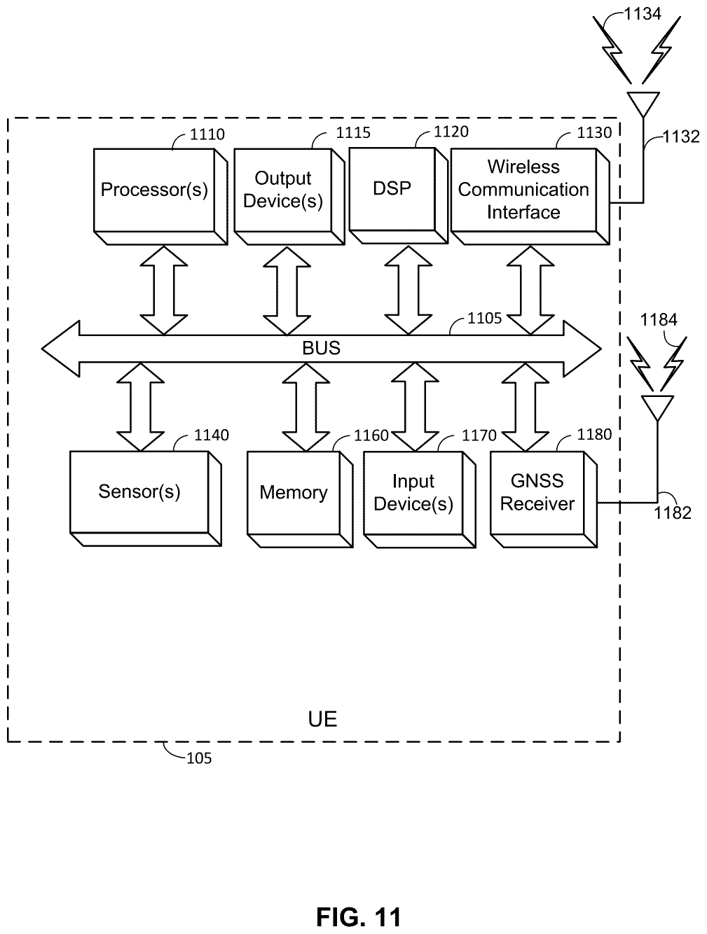

In FIG. 10 is a flow diagram of a method 1000 of modifying transmission of SRS (e.g., SRS for positioning) by a UE during an unconnected state relative to a communication network, according to an embodiment. Means for performing the functionality illustrated in one or more of the blocks shown in FIG. 10 may be performed by hardware and/or software components of a UE. Example components of a UE are illustrated in FIG. 11, which is described in more detail below.

At block 1010, the functionality comprises receiving, at the UE, a first message comprising a first DL message from a TRP via a DL BWP associated with a UL BWP, wherein the first message is received while the UE is configured to transmit one or more SRS instances via an SRS BWP different than the UL BWP while the UE is in the unconnected state relative to the communication network. The DL BWP and UL BWP may be paired and may be known as the initial BWP (e.g., for DL or UL) As noted in the previously-described examples, a first message (e.g., first message 910) may be received as part of a PRACH process. The UL BWP and SRS BWP may have the same center frequency, or may have different center frequencies. Means for performing functionality at block 1010 may comprise bus 1105, processor 1110, digital signal processor (DSP) 1120, wireless communication interface 1130, memory 1160, and/or other components of a UE, as illustrated in FIG. 11.

At block 1020, the functionality comprises canceling a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap; (B) the SRS BWP and a BWP of a second message have the common center frequency and a time difference between the scheduled transmission of the SRS instance and the second message is less than the first threshold time gap; (C) the SRS BWP and the DL BWP have different center frequencies and the time difference between the receiving of the first message and the scheduled transmission of the SRS instance is less than an SRS switching time of the UE; or (D) the SRS BWP and the BWP of the second message have the different center frequencies and the time difference between the scheduled transmission of the SRS instance and the second message is less than the SRS switching time of the UE; or (E) a Physical Random Access Channel (PRACH) has been transmitted by the UE wherein the first threshold time gap is shorter than the SRS switching time of the UE and the second message comprises a second DL message from the TRP or a UL message from the UE. As previously noted, according to some embodiments, the first threshold time gap may be based on an SCS configuration of the UL BWP (e.g., the initial BWP) or a separate SCS configuration provided to the UE. In such embodiments, the first threshold time gap may be based on a number of one or more symbols in an OFDM communication scheme. As previously noted, some embodiments may set the first threshold time gap as a single symbol. According to some embodiments, the first threshold time gap may be measured from the time between the last symbol of the first message and the first symbol of the SRS instance.

Depending on desired functionality, the method 1000 may include one or more additional features. For example, according to some embodiments, where canceling the scheduled transmission of the SRS instance based on (D) the SRS BWP and the BWP of the second message have different center frequencies and the time difference between the scheduled transmission of the SRS instance and the second message is less than the SRS switching time of the UE, the method 1000 may further comprise determining a time of the second message based on decoding the first message at the UE. In such embodiments, the first message may be decoded at a time preceding the scheduled transmission of the SRS instance by at least the SRS switching time. Moreover, the time difference between the receiving of the first message and the scheduled transmission of the SRS instance may be greater than a sum of (i) a length of time it takes for the UE to decode the first message and (ii) the SRS switching time preceding the transmission of the SRS instance. As noted, in some instances the first message may comprise a PDCCH message or a PDSCH message and the second message comprises a PUCCH message or a PUSCH message. In some embodiments, the first message comprises a PDSCH message and the second message comprises a PUSCH message. According to some embodiments, the first message and the second message are transmitted as part of a PRACH process. The first message may comprise MSG2, MSG2 PDCCH, MSG4, or MSG4 PDCCH and the second message may comprise a PUCCH message with an ACK/NAK of the first message. Additionally or alternatively, the method 1000 may comprise canceling transmission of all SRS instances of the one or more SRS instances subsequent to the scheduled transmission of the SRS instance. In some embodiments, the SRS may comprise an SRS for positioning. The unconnected state may comprise an RRC Idle state, an RRC Inactive state, or a Discontinuous Reception (DRX) state.

FIG. 11 is a block diagram of an embodiment of a UE 105, which can be utilized as described herein above (e.g., in association with FIGS. 1-10). For example, the UE 105 can perform one or more of the functions of the method shown in FIG. 10. It should be noted that FIG. 11 is meant only to provide a generalized illustration of various components, any or all of which may be utilized as appropriate. It can be noted that, in some instances, components illustrated by FIG. 11 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 11.

The UE 105 is shown comprising hardware elements that can be electrically coupled via a bus 1105 (or may otherwise be in communication, as appropriate). The hardware elements may include a processor(s) 1110 which can include without limitation one or more general-purpose processors (e.g., an application processor), one or more special-purpose processors (such as DSP chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below). The UE 105 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The UE 105 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1130 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

Depending on desired functionality, the wireless communication interface 1130 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000@, WCDMA, and so on. CDMA2000@includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1180 is illustrated in FIG. 11 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1110, DSP 1120, and/or a processor within the wireless communication interface 1130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1110 or DSP 1120.

The UE 105 may further include and/or be in communication with a memory 1160. The memory 1160 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the UE 105 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the UE 105 (and/or processor(s) 1110 or DSP 1120 within UE 105). In some embodiments, then, such code and/or instructions can be used to configure and/or adapt a general-purpose computer (or other device) to perform one or more operations in accordance with the described methods.

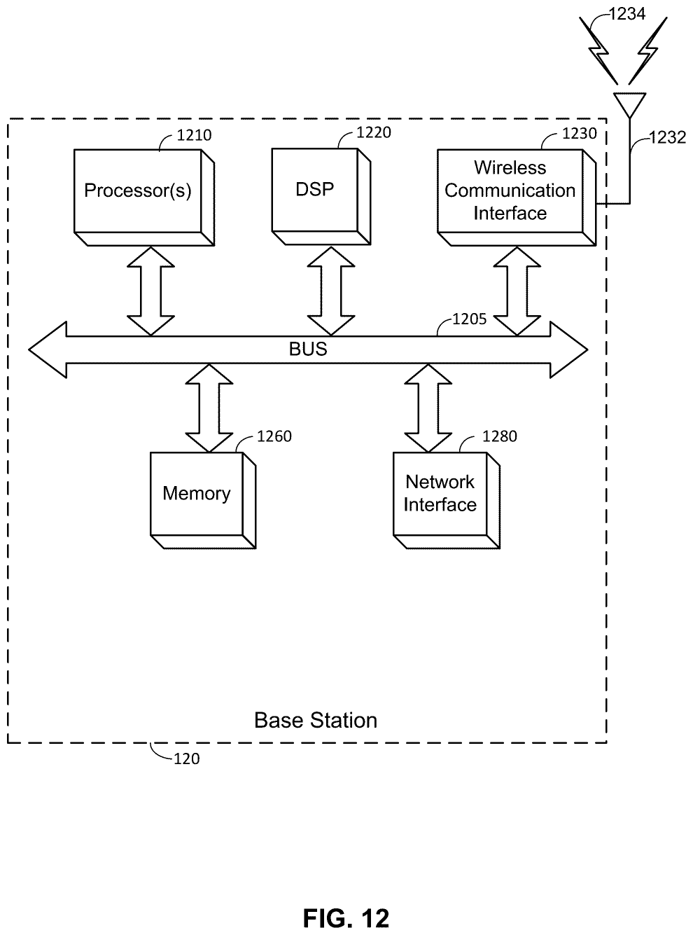

FIG. 12 is a block diagram of an embodiment of a base station 120, which can be utilized as described herein above (e.g., in association with FIGS. 1-11), including the functionality described herein with regard to a TRP. It should be noted that FIG. 12 is meant only to provide a generalized illustration of various components, any or all of which may be utilized as appropriate. In some embodiments, the base station 120 may correspond to a gNB, an ng-eNB, and/or a TRP.

The base station 120 is shown comprising hardware elements that can be electrically coupled via a bus 1205 (or may otherwise be in communication, as appropriate). The hardware elements may include a processor(s) 1210 which can include without limitation one or more general-purpose processors, one or more special-purpose processors (such as DSP chips, graphics acceleration processors, ASICs, and/or the like), and/or other processing structure or means. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1230 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1232 that send and/or receive wireless signals 1234.

The base station 120 may also include a network interface 1280, which can include support of wireline communication technologies. The network interface 1280 may include a modem, network card, chipset, and/or the like. The network interface 1280 may include one or more input and/or output communication interfaces to permit data to be exchanged with a network, communication network servers, computer systems, and/or any other electronic devices described herein.

In many embodiments, the base station 120 may further comprise a memory 1260. The memory 1260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1260 of the base station 120 also may comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the base station 120 (and/or processor(s) 1210 or DSP 1220 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of modifying transmission of sounding reference signal (SRS) by a user equipment (UE) during an unconnected state relative to a communication network, the method comprising: receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and canceling a scheduled transmission of an SRS instance of the one or more SRS instances based on determining: the SRS BWP and the DL BWP have a common center frequency and a time difference between the receiving of the first message and the scheduled transmission of the SRS instance is less than a first threshold time gap; the SRS BWP and a BWP of a second message have the common center frequency and a time difference between the scheduled transmission of the SRS instance and the second message is less than the first threshold time gap; the SRS BWP and the DL BWP have different center frequencies and the time difference between the receiving of the first message and the scheduled transmission of the SRS instance is less than an SRS switching time of the UE; the SRS BWP and the BWP of the second message have the different center frequencies and the time difference between the scheduled transmission of the SRS instance and the second message is less than the SRS switching time of the UE; or a Physical Random Access Channel (PRACH) has been transmitted by the UE; wherein the first threshold time gap is shorter than the SRS switching time of the UE and the second message comprises a second DL message from the TRP or a UL message from the UE.
Clause 2. The method of clause 1, wherein the first threshold time gap is based on an subcarrier spacing (SCS) configuration of the UL BWP or a separate SCS configuration provided to the UE.
Clause 3. The method of clause 1 wherein the first threshold time gap is based on a number of one or more symbols in an orthogonal frequency-division multiplexing (OFDM) communication scheme.
Clause 4. The method of any of clauses 1-3 wherein canceling the scheduled transmission of the SRS instance based on the SRS BWP and the BWP of the second message have different center frequencies and the time difference between the scheduled transmission of the SRS instance and the second message is less than the SRS switching time of the UE, and wherein the method further comprises determining a time of the second message based on decoding the first message at the UE.
Clause 5. The method of any of clause 4 wherein the first message is decoded at a time preceding the scheduled transmission of the SRS instance by at least the SRS switching time.
Clause 6. The method of clause 5 wherein the time difference between the receiving of the first message and the scheduled transmission of the SRS instance is greater than a sum of (i) a length of time it takes for the UE to decode the first message and (ii) the SRS switching time preceding the scheduled transmission of the SRS instance.
Clause 7. The method of clause 6 wherein the first message comprises a Physical Downlink Control Channel (PDCCH) message or a Physical Downlink Shared Channel (PDSCH) message and the second message comprises a Physical Uplink Control Channel (PUCCH) message or a Physical Uplink Shared Channel (PUSCH) message.
Clause 8. The method of clause 6 wherein the first message and the second message are transmitted as part of a PRACH process.
Clause 9. The method of clause 8 wherein the first message comprises MSG2, MSG2 PDCCH, MSG4, or MSG4 PDCCH and the second message comprises a PUCCH message with an ACK/NAK of the first message.
Clause 10. The method of any of clauses 1-9 further comprising canceling transmission of all SRS instances of the one or more SRS instances subsequent to the scheduled transmission of the SRS instance.
Clause 11. The method of any of clauses 1-10 wherein the SRS comprises an SRS for positioning.
Clause 12. The method of any of clauses 1-11 wherein the unconnected state comprises a Radio Resource Control (RRC) Idle state, an RRC Inactive state, or a Discontinuous Reception (DRX) state.
Clause 13. A user equipment (UE) for modifying transmission of sounding reference signal (SRS) during an unconnected state relative to a communication network, the UE comprising: a transceiver; a memory; and one or more processors communicatively coupled with the transceiver and the memory, wherein the one or more processors are configured to: receive, via the transceiver, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and cancel a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap; (B) the SRS BWP and a BWP of a second message have the common center frequency and a time difference between the scheduled transmission of the SRS instance and the second message is less than the first threshold time gap; (C) the SRS BWP and the DL BWP have different center frequencies and the time difference between the receiving of the first message and the scheduled transmission of the SRS instance is less than an SRS switching time of the UE; (D) the SRS BWP and the BWP of the second message have the different center frequencies and the time difference between the scheduled transmission of the SRS instance and the second message is less than the SRS switching time of the UE; or (E) a Physical Random Access Channel (PRACH) has been transmitted by the UE; wherein the first threshold time gap is shorter than the SRS switching time of the UE and the second message comprises a second DL message from the TRP or a UL message from the UE.
Clause 14. The user equipment of clause 13, wherein the one or more processors are configured to determine the first threshold time gap based on an subcarrier spacing (SCS) configuration of the UL BWP or a separate SCS configuration provided to the UE.
Clause 15. The user equipment of clause 13 wherein the one or more processors are configured to determine the first threshold time gap based on a number of one or more symbols in an orthogonal frequency-division multiplexing (OFDM) communication scheme.
Clause 16. The user equipment of any of clauses 13-15 the one or more processors are configured to determine a time of the second message based on decoding the first message at the UE when canceling the scheduled transmission of the SRS instance based on the determination that SRS BWP and the BWP of the second message have different center frequencies and the time difference between the scheduled transmission of the SRS instance and the second message is less than the SRS switching time of the UE.
Clause 17. The user equipment of clause 16 wherein the one or more processors are configured to decode the first message at a time preceding the scheduled transmission of the SRS instance by at least the SRS switching time.
Clause 18. The user equipment of clause 17 wherein the time difference between the receiving of the first message and the scheduled transmission of the SRS instance is greater than a sum of (i) a length of time it takes for the one or more processors to decode the first message and (ii) the SRS switching time preceding the scheduled transmission of the SRS instance.
Clause 19. The user equipment of clause 18 wherein the first message comprises a Physical Downlink Control Channel (PDCCH) message or a Physical Downlink Shared Channel (PDSCH) message and the second message comprises a Physical Uplink Control Channel (PUCCH) message or a Physical Uplink Shared Channel (PUSCH) message.
Clause 20. The user equipment of clause 18 wherein the first message and the second message are transmitted as part of a PRACH process.
Clause 21. The user equipment of clause 20 wherein the first message comprises MSG2, MSG2 PDCCH, MSG4, or MSG4 PDCCH and the second message comprises a PUCCH message with an ACK/NAK of the first message.
Clause 22. The user equipment of any of clauses 13-21 wherein the one or more processors are further configured to cancel transmission of all SRS instances of the one or more SRS instances subsequent to the scheduled transmission of the SRS instance.
Clause 23. The user equipment of any of clauses 13-22 wherein the SRS comprises an SRS for positioning.
Clause 24. The user equipment of any of clauses 13-23 wherein the unconnected state comprises a Radio Resource Control (RRC) Idle state, an RRC Inactive state, or a Discontinuous Reception (DRX) state.
Clause 25. An apparatus for modifying transmission of sounding reference signal (SRS) by a user equipment (UE) during an unconnected state relative to a communication network, the apparatus comprising: means for receiving a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and means for canceling a scheduled transmission of an SRS instance of the one or more SRS instances by the UE based on determining: (A) the SRS BWP and the DL BWP have a common center frequency and a time difference between the receiving of the first message and the scheduled transmission of the SRS instance is less than a first threshold time gap; (B) the SRS BWP and a BWP of a second message have the common center frequency and a time difference between the scheduled transmission of the SRS instance and the second message is less than the first threshold time gap; (C) the SRS BWP and the DL BWP have different center frequencies and the time difference between the receiving of the first message and the scheduled transmission of the SRS instance is less than an SRS switching time of the UE; (D) the SRS BWP and the BWP of the second message have the different center frequencies and the time difference between the scheduled transmission of the SRS instance and the second message is less than the SRS switching time of the UE; or (E) a Physical Random Access Channel (PRACH) has been transmitted by the UE; wherein the first threshold time gap is shorter than the SRS switching time of the UE and the second message comprises a second DL message from the TRP or a UL message from the UE.
Clause 26. The apparatus of clause 25, further comprising means for determining the first threshold time gap based on an subcarrier spacing (SCS) configuration of the UL BWP or a separate SCS configuration provided to the UE.
Clause 27. The apparatus of clause 26 further comprising means for determining the first threshold time gap based on a number of one or more symbols in an orthogonal frequency-division multiplexing (OFDM) communication scheme.
Clause 28. The apparatus of any of clauses 25-27 further comprising means for determining a time of the second message based on decoding the first message at the UE when canceling the scheduled transmission of the SRS instance based on the determination that the SRS BWP and the BWP of the second message have different center frequencies and the time difference between the scheduled transmission of the SRS instance and the second message is less than the SRS switching time of the UE, and wherein the method further comprises.
Clause 29. The apparatus of clause 28 wherein the apparatus is configured to decode the first message at a time preceding the scheduled transmission of the SRS instance by at least the SRS switching time.
Clause 30. A non-transitory computer-readable medium storing instructions for modifying transmission of sounding reference signal (SRS) by a user equipment (UE) during an unconnected state relative to a communication network, the instructions comprising code for: receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and canceling a scheduled transmission of an SRS instance of the one or more SRS instances based on determining: (A) the SRS BWP and the DL BWP have a common center frequency and a time difference between the receiving of the first message and the scheduled transmission of the SRS instance is less than a first threshold time gap; (B) the SRS BWP and a BWP of a second message have the common center frequency and a time difference between the scheduled transmission of the SRS instance and the second message is less than the first threshold time gap; (C) the SRS BWP and the DL BWP have different center frequencies and the time difference between the receiving of the first message and the scheduled transmission of the SRS instance is less than an SRS switching time of the UE; (D) the SRS BWP and the BWP of the second message have the different center frequencies and the time difference between the scheduled transmission of the SRS instance and the second message is less than the SRS switching time of the UE; or (E) a Physical Random Access Channel (PRACH) has been transmitted by the UE; wherein the first threshold time gap is shorter than the SRS switching time of the UE and the second message comprises a second DL message from the TRP or a UL message from the UE.

What is claimed is:

1. A method of modifying transmission of sounding reference signal (SRS) by a user equipment (UE) during an unconnected state relative to a communication network, the method comprising:
receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and
canceling a scheduled transmission of an SRS instance of the one or more SRS instances based on determining:
(A) the SRS BWP and the DL BWP have a common center frequency and a time difference between the receiving of the first message and the scheduled transmission of the SRS instance is less than a first threshold time gap;
(B) the SRS BWP and a BWP of a second message have the common center frequency and a time difference between the scheduled transmission of the SRS instance and the second message is less than the first threshold time gap;
(C) the SRS BWP and the DL BWP have different center frequencies and the time difference between the receiving of the first message and the scheduled transmission of the SRS instance is less than an SRS switching time of the UE;
(D) the SRS BWP and the BWP of the second message have the different center frequencies and the time difference between the scheduled transmission of the SRS instance and the second message is less than the SRS switching time of the UE; or
(E) a Physical Random Access Channel (PRACH) has been transmitted by the UE;
wherein the first threshold time gap is shorter than the SRS switching time of the UE and the second message comprises a second DL message from the TRP or a UL message from the UE.

2. The method of claim 1, wherein the first threshold time gap is based on an subcarrier spacing (SCS) configuration of the UL BWP or a separate SCS configuration provided to the UE.

3. The method of claim 2, wherein the first threshold time gap is based on a number of one or more symbols in an orthogonal frequency-division multiplexing (OFDM) communication scheme.

4. The method of claim 1, wherein canceling the scheduled transmission of the SRS instance based on the SRS BWP and the BWP of the second message have different center frequencies and the time difference between the scheduled transmission of the SRS instance and the second message is less than the SRS switching time of the UE, and wherein the method further comprises determining a time of the second message based on decoding the first message at the UE.

5. The method of claim 4, wherein the first message is decoded at a time preceding the scheduled transmission of the SRS instance by at least the SRS switching time.

6. The method of claim 5, wherein the time difference between the receiving of the first message and the scheduled transmission of the SRS instance is greater than a sum of (i) a length of time it takes for the UE to decode the first message and (ii) the SRS switching time preceding the scheduled transmission of the SRS instance.

7. The method of claim 6, wherein the first message comprises a Physical Downlink Control Channel (PDCCH) message or a Physical Downlink Shared Channel (PDSCH) message and the second message comprises a Physical Uplink Control Channel (PUCCH) message or a Physical Uplink Shared Channel (PUSCH) message.

8. The method of claim 6, wherein the first message and the second message are transmitted as part of a PRACH process.

9. The method of claim 8, wherein the first message comprises MSG2, MSG2 PDCCH, MSG4, or MSG4 PDCCH and the second message comprises a PUCCH message with an ACK/NAK of the first message.

10. The method of claim 1, further comprising canceling transmission of all SRS instances of the one or more SRS instances subsequent to the scheduled transmission of the SRS instance.

11. The method of claim 1, wherein the SRS comprises an SRS for positioning.

12. The method of claim 1, wherein the unconnected state comprises a Radio Resource Control (RRC) Idle state, an RRC Inactive state, or a Discontinuous Reception (DRX) state.

13. A user equipment (UE) for modifying transmission of sounding reference signal (SRS) during an unconnected state relative to a communication network, the UE comprising:
a transceiver;
a memory; and
one or more processors communicatively coupled with the transceiver and the memory, wherein the one or more processors are configured to:
receive, via the transceiver, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and
cancel a scheduled transmission of an SRS instance of the one or more SRS instances based on determining:
(A) the SRS BWP and the DL BWP have a common center frequency and a time difference between the receiving of the first message and the scheduled transmission of the SRS instance is less than a first threshold time gap;
(B) the SRS BWP and a BWP of a second message have the common center frequency and a time difference between the scheduled transmission of the SRS instance and the second message is less than the first threshold time gap;
(C) the SRS BWP and the DL BWP have different center frequencies and the time difference between the receiving of the first message and the scheduled transmission of the SRS instance is less than an SRS switching time of the UE;
(D) the SRS BWP and the BWP of the second message have the different center frequencies and the time difference between the scheduled transmission of the SRS instance and the second message is less than the SRS switching time of the UE; or
(E) a Physical Random Access Channel (PRACH) has been transmitted by the UE;
wherein the first threshold time gap is shorter than the SRS switching time of the UE and the second message comprises a second DL message from the TRP or a UL message from the UE.

14. The UE of claim 13, wherein the one or more processors are configured to determine the first threshold time gap based on an subcarrier spacing (SCS) configuration of the UL BWP or a separate SCS configuration provided to the UE.

15. The UE of claim 14, wherein the one or more processors are configured to determine the first threshold time gap based on a number of one or more symbols in an orthogonal frequency-division multiplexing (OFDM) communication scheme.

16. The UE of claim 13, the one or more processors are configured to determine a time of the second message based on decoding the first message at the UE when canceling the scheduled transmission of the SRS instance based on the determination that the SRS BWP and the BWP of the second message have different center frequencies and the time difference between the scheduled transmission of the SRS instance and the second message is less than the SRS switching time of the UE.

17. The UE of claim 16, wherein the one or more processors are configured to decode the first message at a time preceding the scheduled transmission of the SRS instance by at least the SRS switching time.

18. The UE of claim 17, wherein the time difference between the receiving of the first message and the scheduled transmission of the SRS instance is greater than a sum of (i) a length of time it takes for the one or more processors to decode the first message and (ii) the SRS switching time preceding the scheduled transmission of the SRS instance.

19. The UE of claim 18, wherein the first message comprises a Physical Downlink Control Channel (PDCCH) message or a Physical Downlink Shared Channel (PDSCH) message and the second message comprises a Physical Uplink Control Channel (PUCCH) message or a Physical Uplink Shared Channel (PUSCH) message.

20. The UE of claim 18, wherein the first message and the second message are transmitted as part of a PRACH process.

21. The UE of claim 20, wherein the first message comprises MSG2, MSG2 PDCCH, MSG4, or MSG4 PDCCH and the second message comprises a PUCCH message with an ACK/NAK of the first message.

22. The UE of claim 13, wherein the one or more processors are further configured to cancel transmission of all SRS instances of the one or more SRS instances subsequent to the scheduled transmission of the SRS instance.

23. The UE of claim 13, wherein the SRS comprises an SRS for positioning.

24. The UE of claim 13, wherein the unconnected state comprises a Radio Resource Control (RRC) Idle state, an RRC Inactive state, or a Discontinuous Reception (DRX) state.

25. An apparatus for modifying transmission of sounding reference signal (SRS) by a user equipment (UE) during an unconnected state relative to a communication network, the apparatus comprising:
means for receiving a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and
means for canceling a scheduled transmission of an SRS instance of the one or more SRS instances by the UE based on determining:
(A) the SRS BWP and the DL BWP have a common center frequency and a time difference between the receiving of the first message and the scheduled transmission of the SRS instance is less than a first threshold time gap;
(B) the SRS BWP and a BWP of a second message have the common center frequency and a time difference between the scheduled transmission of the SRS instance and the second message is less than the first threshold time gap;
(C) the SRS BWP and the DL BWP have different center frequencies and the time difference between the receiving of the first message and the scheduled transmission of the SRS instance is less than an SRS switching time of the UE;
(D) the SRS BWP and the BWP of the second message have the different center frequencies and the time difference between the scheduled transmission of the SRS instance and the second message is less than the SRS switching time of the UE; or
(E) a Physical Random Access Channel (PRACH) has been transmitted by the UE;
wherein the first threshold time gap is shorter than the SRS switching time of the UE and the second message comprises a second DL message from the TRP or a UL message from the UE.

26. The apparatus of claim 25, further comprising means for determining the first threshold time gap based on an subcarrier spacing (SCS) configuration of the UL BWP or a separate SCS configuration provided to the UE.

27. The apparatus of claim 26, further comprising means for determining the first threshold time gap based on a number of one or more symbols in an orthogonal frequency-division multiplexing (OFDM) communication scheme.

28. The apparatus of claim 25, further comprising means for determining a time of the second message based on decoding the first message at the UE when canceling the scheduled transmission of the SRS instance based on the determination that the SRS BWP and the BWP of the second message have different center frequencies and the time difference between the scheduled transmission of the SRS instance and the second message is less than the SRS switching time of the UE.

29. The apparatus of claim 28, wherein the apparatus is configured to decode the first message at a time preceding the scheduled transmission of the SRS instance by at least the SRS switching time.

30. A non-transitory computer-readable medium storing instructions for modifying transmission of sounding reference signal (SRS) by a user equipment (UE) during an unconnected state relative to a communication network, the instructions comprising code for:
receiving, at the UE, a first message comprising a first downlink (DL) message from a transmission/reception point (TRP) via a DL bandwidth part (BWP) associated with an uplink (UL) BWP, wherein the first message is received while the UE is configured to transmit one or more SRS instances via an SRS BWP different than the UL BWP while the UE is in the unconnected state relative to the communication network; and
canceling a scheduled transmission of an SRS instance of the one or more SRS instances based on determining:
(A) the SRS BWP and the DL BWP have a common center frequency and a time difference between the receiving of the first message and the scheduled transmission of the SRS instance is less than a first threshold time gap;
(B) the SRS BWP and a BWP of a second message have the common center frequency and a time difference between the scheduled transmission of the SRS instance and the second message is less than the first threshold time gap;
(C) the SRS BWP and the DL BWP have different center frequencies and the time difference between the receiving of the first message and the scheduled transmission of the SRS instance is less than an SRS switching time of the UE;
(D) the SRS BWP and the BWP of the second message have the different center frequencies and the time difference between the scheduled transmission of the SRS instance and the second message is less than the SRS switching time of the UE; or
(E) a Physical Random Access Channel (PRACH) has been transmitted by the UE;
wherein the first threshold time gap is shorter than the SRS switching time of the UE and the second message comprises a second DL message from the TRP or a UL message from the UE.
